(19) United States
(12) Patent Application Publication
(10) Pub. No.: US 2009/0120507 A1
(43) Pub. Date: May 14, 2009

(54) FLUID METERING AND PUMPING DEVICE

(75) Inventors: James K. Simonelli, Buford, GA (US); John E. Purcell, Commerce, GA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Roper Pump Company, Commerce, GA (US)

(21) Appl. No.: 12/271,537

(22) Filed: Nov. 14, 2008

Related U.S. Application Data
(60) Provisional application No. 60/987,954, filed on Nov. 14, 2007.

(51) Int. Cl. G05D 11/02; F04C 2/08; G05D 11/13; G05D 7/00

(52) U.S. Cl. 137/99; 417/423.14

(57) ABSTRACT

A fluid metering/pumping device preferably includes a series of intermeshing gears. The fluid metering/pumping device includes an inlet port or area adjacent the intermeshing portion of each pair of gears within the series adjacent the point at which the pair of gears diverge. The device further includes a pressure loaded floating shoe adjacent the intermeshing portion of each pair of gears within the series adjacent the point at which the pair of gears converge. The device further includes a piston subjected to discharge pressure at each discharge port which conveys hydraulic pressure to each floating shoe. The device is configured to convey liquid from a main inlet stream of liquid, through the inlet ports or areas, and out of one or more discharge ports at substantially equal rates.

### CROSS-REFERENCE TO RELATED APPLICATIONS

This application claims the benefit under 35 U.S.C. § 119(e) of Provisional Application Ser. No. 60/987,954 filed on Nov. 14, 2007, entitled FLUID METERING AND PUMPING DEVICE and whose entire disclosure is incorporated by reference herein.

### BACKGROUND OF THE INVENTION

1. Field of Invention

This invention relates generally to devices for regulating the flow of liquids, and more particularly, to flow dividers for dividing a stream of liquid, such as liquid fuel, into two or more smaller streams of liquid and to pumps for pumping a single flow of liquid to one or more locations in substantially accurate flow rates.

2. Description of Related Art

When working with liquids, it is often desirable to divide a single stream of liquid into several smaller, equal streams of liquid or several substantially accurate streams of liquid. This is typically done using a fluid metering device such as liquid flow divider, an equal-flow pump, or an equal-flow liquid motor.

A typical prior art liquid flow divider is taught in U.S. Pat. No. 4,531,535 to Kiernan (hereinafter also referred to as “Kiernan”). As shown in FIG. 4 of Kiernan, such liquid flow dividers typically include multiple dividing units of two intermeshed spur gears. The various dividing units are typically linked together by a drive train that may include a drive line, drive shafts, or a sun gear. As a result of this linkage, all of the gears within the various dividing units rotate at substantially the same speed.

Within each individual dividing unit, a liquid inlet port is positioned on one side of the intermeshing portion of the pair of spur gears, and a liquid discharge port is positioned on the other side of the intermeshing portion of the pair of spur gears. A housing is provided that conforms to the exterior portions of the spur gears that are not in communication with the liquid inlet port or the liquid discharge port. All of the various dividing units' liquid inlet ports are in communication with a single, pressurized liquid source.

In operation, pressurized liquid from the pressurized liquid source first enters each dividing unit's liquid inlet port. The pressurized liquid then causes the gears in each dividing unit to rotate in opposite directions so that each gear's teeth carry liquid from the liquid inlet port, around the exterior portion of the gear, and into the liquid discharge port. Because all of the dividing gears within the liquid flow divider are preferably the same size and shape, and because the gears are linked together by a central drive train so that all of the gears rotate at the same rate, the flow rate of liquid around each of the flow divider's various gears is identical to the flow rate of liquid around each of the flow divider's other gears. Since each dividing unit includes two gears that convey liquid from the dividing unit's liquid inlet port to the dividing unit's liquid discharge port, liquid flows through each dividing unit at a rate that is equal to two times the rate at which the liquid flows around a single gear.

Accordingly, prior art liquid flow dividers are typically designed to include one dividing unit for each equal discharge stream that the flow divider is to produce. For example, if the flow divider is to produce ten equal discharge streams of liquid, the flow divider will include ten separate dividing units. As noted above, these dividing units are linked together by a drive train, such as a drive line or a central sun gear.

U.S. Pat. No. 6,857,441 B2 to Flavelle shows away to simplify the drive train in such a flow divider. However, such prior art liquid flow dividers, including the flow dividers described above, have significant disadvantages. First, because the drive trains within these flow dividers are typically less robust than the other components within the flow dividers, the drive trains often break or otherwise malfunction. Secondly, a tolerance stack-up between the mating parts can result in excessive running clearances between the gear outer diameter (OD) and the case bore interior diameter (ID) which, in turn, results in excessive fluid slip between the inlet and discharge side of the gears and produces inaccuracies in the liquid flow streams.

Accordingly, there is a need for improved liquid flow dividers, pumps and other fluid metering devices with parts having tolerances that can be more easily manufactured but still result in very close clearances between the gear OD and the case bore ID to reduce the fluid slip through the clearances which greatly improves the accuracy of the liquid flow stream or streams.

A prior art approach to reducing the clearances between the gears and the housing in a pump is shown in U.S. Pat. No. 4,127,365 to Martinet al. (hereinafter also referred to as “Martin”). In Martin, a moveable suction shoe surrounds the meshing point of the gears, and the shoe also covers the suction port, where liquid enters the pump. The higher pressure at the pump's outlet bears on the full outside surface area of the shoe, and pushes it firmly against the ends of the gears and against the tips of the gear teeth. This greatly reduces slip in the pump, but causes a problem that the difference between suction pressure and discharge pressure increases because an increasingly large load has to be borne by the tips of the gear teeth as the shoe is pressed harder and harder against the gears. In practice, this effect limits the suction shoe concept to pumps that only operate at low differential pressures. Also, the suction shoe cannot be used in a flow divider as described above because, unlike a pump, either the inlet or outlet port of a flow divider may be at a higher pressure than the other port.

In Martin, the lower pressure must at all times remain on the inside of the shoe. If the pressure inside the shoe becomes greater than the pressure outside the shoe, then the internal pressure will push the shoe away from the gears until the pump ceases moving any fluid. So, there is also a need for a way to balance the forces on the shoe, and to be able to control the forces whatever the pressure change at the pump or flow divider's port may be. All references cited herein are incorporated herein by reference in their entireties.

### BRIEF SUMMARY OF THE INVENTION

The exemplary embodiments include a fluid metering or pumping device including first and second gears, a housing and a floating shoe. The second gear is disposed adjacent the first gear and intermeshes with the first gear. The housing surrounds the gears and seals them from outside liquid contact. Preferably, the housing is not in close contact with the gears, but still forms a chamber around the gears that is in liquid communication with a port that may be used to allow liquid either into or out of the pumps or fluid metering device. The floating shoe partially extends into the port of the pump, forming a first chamber defined by the port opening, the part of the shoe extending into the port, and the interior walls of the housing. Preferably, the floating shoe is not connected to the chamber surrounding the gears, but is in contact with both gears. The floating shoe forms a second chamber also defined by the outer surface of the gears between the contact point between the gears and the second chamber, and the gear mesh point. This second chamber is in liquid communication with the port that the shoe partially extends into, with the cross sectional areas of the second chamber formed by the gears and shoe, and the part of the shoe extending into the port being equal. In other words, the liquid pressure applied to the outward facing surface of the part of the floating shoe extending into the port is balanced with (e.g., equal to with a minimal force to maintain contact between the shoe and the gears) the liquid pressure applied to the inward facing surface of the shoe in the second chamber. By balanced, it is understood that some minimal force is preferred between the shoe and the gears to keep the gears in contact with the shoe even when the remaining pressures applied to the outward facing surface of the shoe extending into the port and to the inward facing surface of the shoe are equal. This minimal force may be applied by an additional force applied inward onto the shoe or outward against the gears. Alternative approaches for providing this minimal contact force include adjusting the surfaces of the shoe to acquire a slightly greater inward pressure than outward pressure, or a compression spring.

Additional gears may be arranged adjacent the first two gears with at least one of the additional gears intermeshed with one of the first two gears and also intermeshed with each other to form a line or circle of intermeshed gears. In this scenario, each pair of gears contacts a separate floating shoe and forms multiple pumps or fluid metering devices.

According to another exemplary embodiment, the floating shoe described above is divided into two members. The first member includes a part of the shoe that contacts the gears, and the second member includes a part of the shoe which extends into one of the liquid ports of the device. Both members are free to move towards or away from each other depending on the force exerted on them by the liquid in the two ports of the device. In this exemplary embodiment, which is configured with cross sectional areas of the inside facing walls of the shoe contacting the gears, with the outward facing wall of the part of the shoe extending into one port, and with the manner that the two pieces of the shoe fit together, a small centering force always presses the part of the shoe in contact with the gears towards the gears, regardless of which port contains a higher liquid pressure.

### BRIEF DESCRIPTION OF SEVERAL VIEWS OF THE DRAWINGS

The invention will be described in conjunction with the following drawings in which like reference numerals designate like elements, and wherein:

FIG. 1 is a cross sectional side view of an exemplary embodiment of the invention perpendicular to a gears' axis of rotation;

FIG. 2 is a cross sectional side view of the embodiment of FIG. 1 parallel to the gears' axis of rotation;

FIG. 3 is a cross sectional side view of a two piece shoe in accordance with the preferred embodiments of the invention;

FIG. 4 is a cross sectional side view of a two piece shoe in accordance with the preferred embodiments of the invention;

FIG. 5 is a cross sectional side view of a multi-section pump or flow divider in accordance with the preferred embodiments of the invention; and

FIG. 6 is a cross sectional side view of a multi-section pump or flow divider with a central gear in accordance with the preferred embodiments of the invention.

### DETAILED DESCRIPTION OF THE PREFERRED EMBODIMENTS

The present invention provides a fluid metering device, such as a liquid flow divider or pump, that has tolerances that are more easily manufactured and have no tolerance stack-up between the gear OD and the pressure loaded shoe ID that will increase the fluid slip between the gear OD and the pressure loaded shoe ID. While not being limited to a particular theory, each gear in the metering or pumping unit intermeshes with adjacent gears, which eliminates the need for a separate drive train between the elements of multi-element units that are typically less robust than the other components in the unit. More particularly, a preferred liquid metering device includes two or more gears located adjacent to each other that intermesh with the adjacent gears.

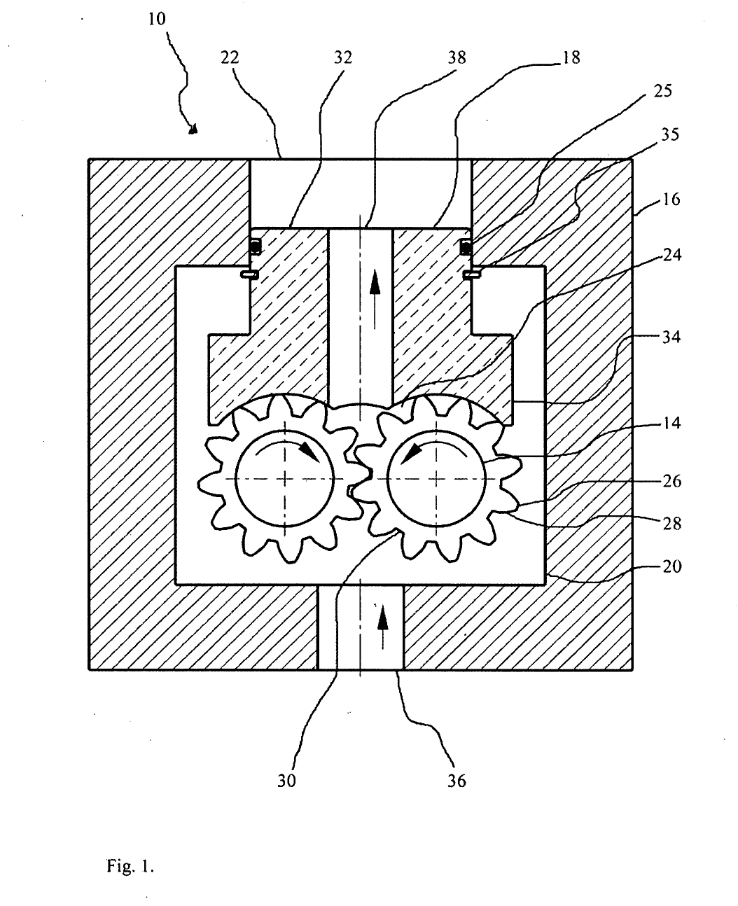

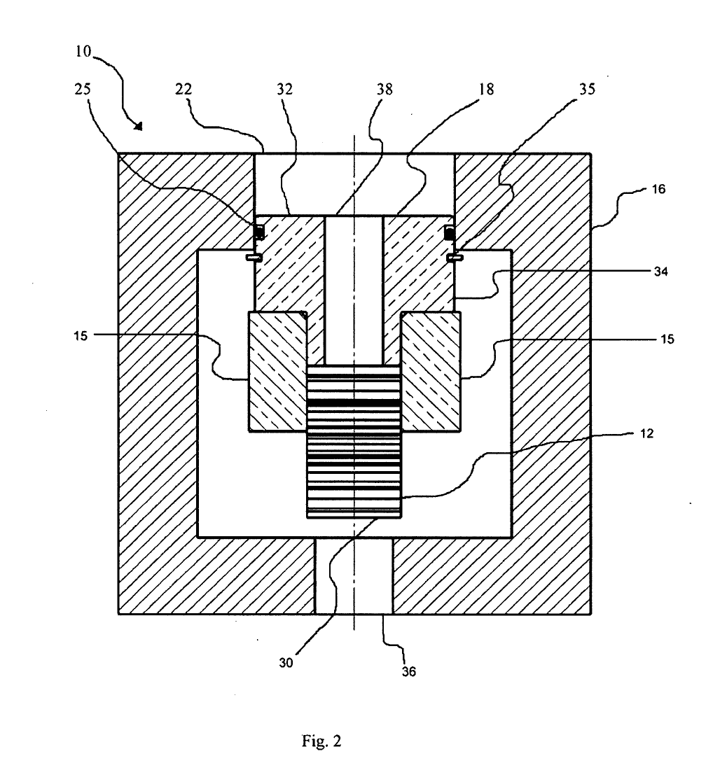

FIGS. 1 and 2 depict an exemplary fluid metering device 10 shown in cross-section perpendicular and parallel, respectively, to a gear's axis of rotation as will be described in greater detail below. As can best be seen in FIG. 1, the fluid metering device 10 includes a first gear 12, a second gear 14, a housing 16 and a floating shoe 18. The second gear 14 is disposed adjacent the first gear 12 and intermeshes with the first gear. The housing 16 surrounds the gears and seals them from outside liquid contact exterior of the housing, except through the first and second port as will be discussed in greater detail below. Preferably, the housing 16 is not in close or touching contact with the gears 12, 14, but still forms a first chamber 20 around the gears that is in liquid communication with a first port 22 that may be used to allow liquid either into or out of the fluid metering device 10.

The floating shoe 18 partially extends into the first port 22 of the housing 16. Preferably, the floating shoe 18 is not connected to the first chamber 20 surrounding the gears 12, 14, but is in contact with both gears. The floating shoe defines a second chamber 24 in liquid communication with the first port 22 that the shoe 18 partially extends into via a central bore 38 of the shoe. This second chamber 24 is around the gear mesh point and around one side of the gears. That is, the floating shoe 18 in contact with the pair of gears (e.g., the first and second gears 12, 14) contacts the tips 26 of the gear teeth 28, and also covers the outer edge 30 of the gears to beyond their point of intermeshing, thus forming the second chamber 24 as a sealed cavity in the space between the pair of gears and the floating shoe. This second chamber 24 is connected, through the inside of the shoe 18, to the first port 22 of the device 10, with a first section 32 of the shoe extending out of the chamber 20 surrounding the gears 12, 14 and into the first port.

While not being limited to a particular theory, the area of the outward facing or exterior wall of the first section 32 of the floating shoe 18 that extends into the first port 22 is preferably equal the cross-sectional surface area of the second chamber, including the interior wall of a second part 34 of the floating shoe 18 aligned with the tips 26 of the gear teeth 28 that is exposed to the pressure in the chamber 20 having the two gears 12, 14 and the interior surface space of the shoe. This preferred structural arrangement results in no net force on the shoe 18 from changing pressures at either the first port 22 or a second port 36 of the fluid metering device 10 as shown, for example, in FIGS. 1 and 2.

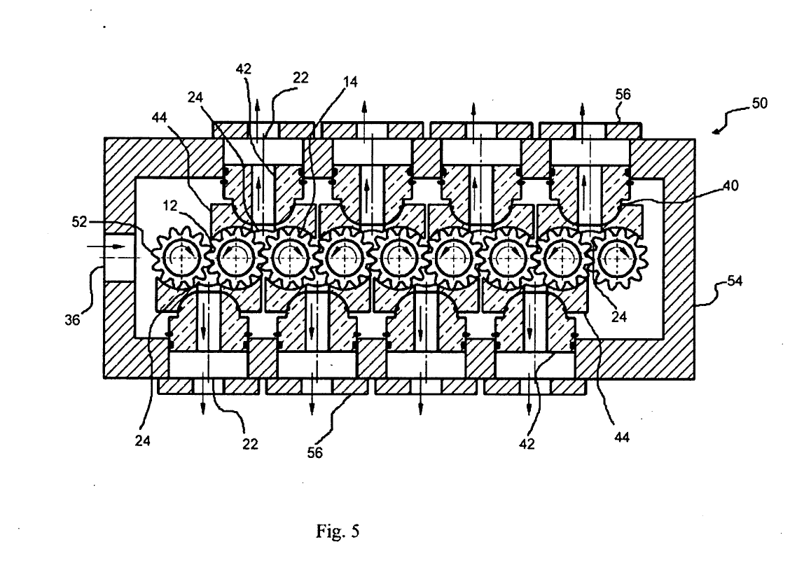

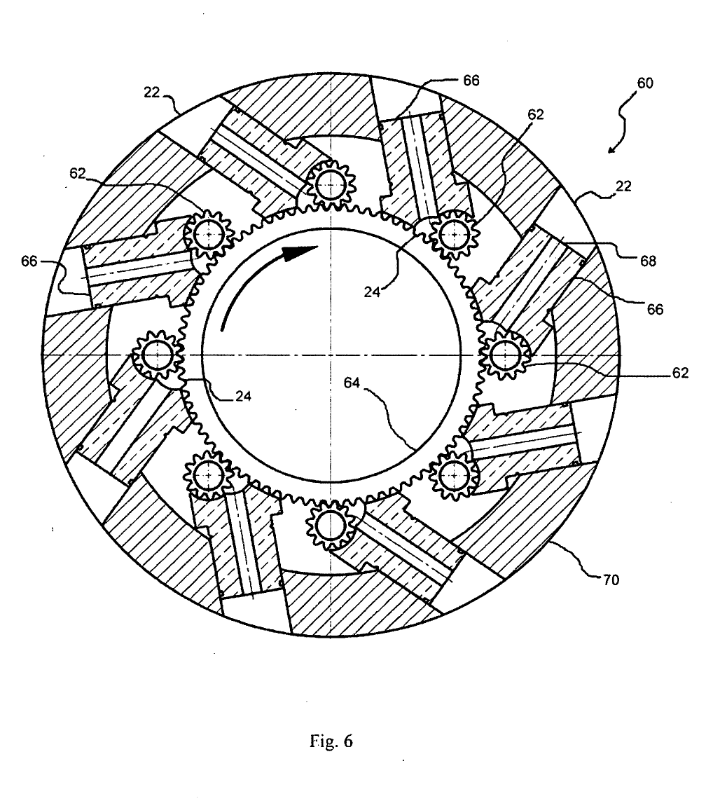

It is noted that, as discussed above for the preferred embodiments, a minimal pressure should be maintained between the floating shoe 18 and the gears 12, 14 to ensure continuous contact between the shoe and the gears. This minimal pressure may be maintained by, for example, added pressure on the exterior wall of the first section 32 of the floating shoe 18, or pressure within the first chamber 20 applied to the exterior facing wall of the shoe within the first chamber. Pressure may be added to the exterior wall of the first section 32 by added fluid pressure or mechanical pressure; such as a compression spring applied in a compressed state between the exterior wall of the first section 32 and a cover 56 over the first port 22 (see FIG. 5). It is more appropriate to add mechanical pressure in very high pressure situations to offset any hysteresis in the device. The net effect is a balancing of the shoe in the device 10 and in contact with the gears regardless of changing pressures at either the first port 22 or a second port 36.

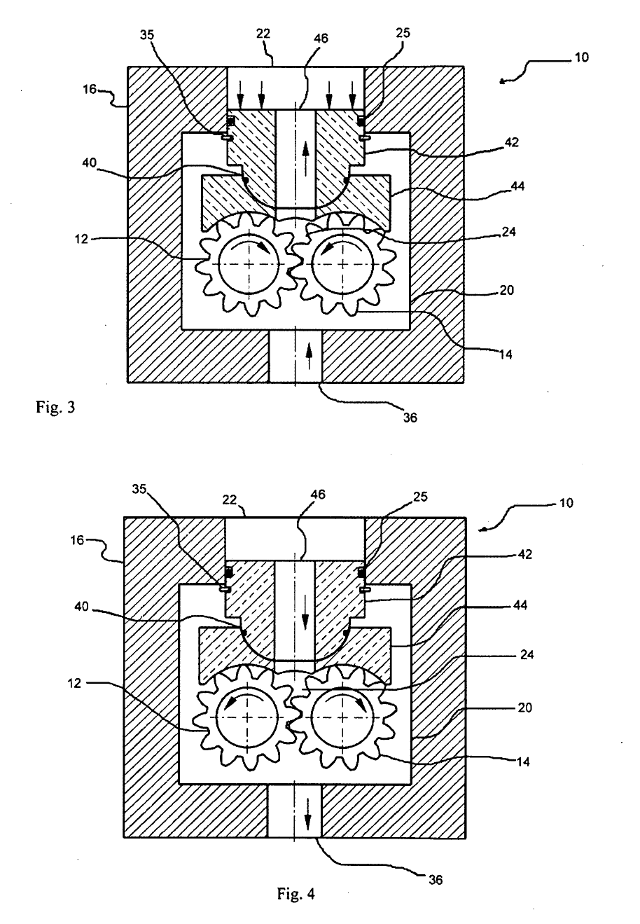

Sometimes it is desirable to have a controllable net force on the shoe, regardless of which port has the higher pressure. In this case, a two-piece shoe 40 as shown, for example, in the fluid metering device 10 of FIGS. 3 and 4, can be used. The two-piece shoe 40 is similar to the floating shoe 18, and includes a first member 42 and a second member 44 cooperatively engageable and sharing a central bore 46 providing fluid communication between the first port 22 and the second chamber 24. If the pressure is higher in the first port 22 that the two-piece shoe 40 extends into, the two members 42, 44 are pushed together—as can best be seen in FIG. 3—and the resultant force on the floating two-piece shoe 40 is a small force proportional to the difference in pressure between the first port 22 and the second port 36.

Still referring to FIGS. 3 and 4, the differences in area inside the chamber 20 between the gears 12, 14 and the floating two-piece shoe 40, and the area of the two-piece shoe exposed to the pressure in the port 22 can be biased to keep a small centering force that holds the two-piece shoe firmly against the gears. If the pressure in the port 22 is less than the pressure in the chamber 20 applied to the two-piece shoe 40, the two parts of the two-piece shoe separate slightly. That is, the first member 42 of the shoe 40 may move toward the port 22 up to there the retaining ring 35 abuts the wall of the housing 16 adjacent the ring, yet the second member 44 remains in contact with the gears due to the pressure in the first chamber 20 applied toward the gears. Here, the differences in area inside and outside the two-piece shoe provide a small controllable centering force to hold the two-piece shoe against the gears, even with a reversal of the pressure difference. That is, the second member 44 is urged into contact with the gears regardless of which port contains a higher liquid pressure.

It is understood that additional gears may be arranged adjacent the first two gears 12, 14 with at least one of the additional gears intermeshed with its adjacent one of the first two gears and also intermeshed with other additional gears to form a plurality of pairs of intermeshed gears. In this scenario each pair of gears contacts a separate floating shoe and forms multiple pumps or fluid flow dividers. In other words, when the fluid metering device includes multiple pumps or flow dividers, the gears may be arranged in a line, as can be seen for example in FIG. 5.

FIG. 5 depicts a fluid metering device 50 with a plurality of gears forming adjacent alternate pairs of gears. For example, gear 12 interconnects with gear 14 to form one pair of gears, and gear 12 also interconnects with a gear 52 to form an adjacent alternate pair of gears. Each pair of adjacent alternate gears shares a respective floating shoe 40, with each floating shoe having first and second members 42, 44 as discussed above, and with successive floating shoes located on alternate sides of the line of gears. Each floating shoe 40 is confined within the housing 54 by a grommet or cover 56 including an aperture 58 preferably aligned with the central bore 46 of the shoe. The cover 56 is a fastener attached to the housing 54 by any approach readily understood by a skilled artisan (e.g., friction, adhesion, force, threaded engagement) and may similarly partially cover the first ports 22 shown in the other figures. While FIG. 5 shows gears arranged in a line, it is understood that the plurality of gears can be arranged in other forms while remaining within the scope of the invention. For example, the gears could be arranged in a curve, circle, polygon or some combination thereof while forming adjacent pairs of gears in contact with respective floating shoes.

FIG. 6 depicts yet another exemplary embodiment, where the fluid metering device 60 is configured as a series of gears 62 arranged around a central gear 64 and all intermeshing with the central gear. In this example, the fluid metering device 60 includes a plurality of floating shoes 66, with each floating shoe again connected to a pair of gears (e.g., the central gear 64 and one of the gears 62). Each floating shoe 66 includes a central bore 68 providing fluid communication between the first port 22 and the second chamber 24, as is consistent with the floating shoes 18, 40 discussed above. While not being limited to a particular theory, in this embodiment, each gear 62 shares its matched floating shoe 66 with the central gear 64. While the central gear 64 is shown significantly larger than each gear 62, the relative proportions of the gears is not critical to the scope of the invention. It is understood that the relative proportions of the gears is influenced by several factors, including but not limited to the number and size of the floating shoes 66, the alignment of the first ports 22 and floating shoes within the housing 70, and the size of the paired gear (e.g., the central gear 64 for each of the series of gears 62, and the respective gear 62 for the central gear 64).

As can best be seen in FIG. 2, each floating shoe 18, 40 and 66 preferably connects to side plates 15 as would readily be understood by a skilled artisan. The side plates 15 extend from the floating shoe 18, 40, 66 about opposite sides of the gears 12, 14, 62, 64 to keep the gears laterally in place, that is, to prevent the gears from sliding off their intermeshed engagement with adjacent gears. It is also noted that each floating shoe also includes an elastic o-ring 25 and a retaining ring 35. The elastic o-ring 25 provides a liquid seal between the floating shoe and its respective housing 16, 54, 70. The retaining ring 35 keeps the floating shoe in a preferred orientation extending into the first port 22 preventing its extension further into the first port beyond the abutment of the retaining ring and the inner wall of the housing.

It is understood that the fluid metering and pumping device described and shown are exemplary indications of preferred embodiments of the invention, and are given by way of illustration only. Many modifications and other embodiments of the invention will come to mind to one skilled in the art to which this invention pertains having the benefit of the teachings presented in the foregoing descriptions and the associated drawings. For example, the gears may have teeth arranged preferably in a 1:1 ratio with matching teeth from adjacent gears, or may have some other intermeshed relationship, such as a 2:1 or 1:2 ratio with teeth from adjacent gears as long as the gears maintain their rotational communicative relationship. Therefore, it is to be understood that the invention is not to be limited to the specific embodiments disclosed, and that modifications and other embodiments are intended to be included within the scope of the appended claims. Although specific terms are employed herein, they are used in a generic and descriptive sense only, and not for purposes of limitation. Without further elaboration, the foregoing will so fully illustrate the invention that others may, by applying current or future knowledge; readily adapt the same for use under various conditions of service.

What is claimed is:

1. A fluid metering or pumping device, comprising:
a first gear;
a second gear disposed adjacent to said first gear so that said second gear intermeshes with said first gear;
a housing surrounding the gears but not touching the gears, the housing having a first chamber and a first port, the first chamber around the gears that is in liquid communication with the first port that may be used to allow liquid either into or out of the device, the housing further including a second port providing liquid communication to the first chamber; and
a floating shoe that partially extends into the first port that is not connected to the first chamber, the floating shoe in contact with both gears and forming a second chamber defined by the floating shoe in contact with the first and second gears and also the outer edge surface of the gears to beyond their point of intermeshing as a sealed cavity in the space between the pair of gears and the floating shoe, the floating shoe having a central bore providing liquid communication between the second chamber and the first port that the floating shoe partially extends into, and the external area of the shoe extending into the first port being equal to the surface area of the second chamber to result in no net force on the floating shoe from changing pressures at either the first port or the second port.

2. The fluid metering or pumping device of claim 1, further comprising additional gears arranged adjacent to the first two gears so the additional gears intermesh with one of the first two and to each other to form a plurality of pairs of adjacent intermeshed gears, each pair of adjacent intermeshed gears having a separate floating shoe in contact with the pair of gears to form multiple pumps or fluid dividers.

3. The fluid metering or pumping device of claim 1, said floating shoe being divided into a first member and a second member, the first member extending into the first port and the second member in contact with the gears, the first and second members being separate and free to move towards or away from each other depending on the force exerted on them by the liquid in the two ports of the device.

4. The fluid metering or pumping device of claim 3, the cross sectional area of the second member of the shoe that contacts the gears, the cross sectional area of the first member of the shoe that extends into the first port, and the first and second members being arranged so that a small centering force presses the second member towards the gears regardless of which port contains a higher liquid pressure.

5. A fluid metering or pumping device, comprising:
a first gear;
a second gear disposed adjacent to said first gear so that said second gear intermeshes with said first gear;
a housing surrounding the gears but not touching the gears, the housing having a first chamber and a first port, the first chamber around the gears that is in liquid communication with the first port that may be used to allow liquid either into or out of the device, the housing further including a second port providing liquid communication to the first chamber; and
a floating shoe having a first member extending into the first port and a second member in contact with the first and second gears, the floating shoe having a central bore providing liquid communication between the second chamber and the first port, the first and second members being separate and free to move towards or away from each other depending on the forces exerted on them by the liquid from the first and second ports, the second member being urged into contact with the gears regardless of which port contains a higher liquid pressure.
